(19) United States
(12) Patent Application Publication
(10) Pub. No.: US 2007/0079832 A1
(43) Pub. Date: Apr. 12, 2007

(54) Devices for assisting respiration of and administering fluid to a patient

(76) Inventors: Mary Baldauf, Valley Stream, NY (US); Thomas Baldauf, Merrick, NY (US)

Correspondence Address: DILWORTH & BARRESE, LLP, 333 EARLE OVINGTON BLVD., SUITE 702, UNIONDALE, NY, 11553, US

(21) Appl. No.: 11/242,153

(22) Filed: Oct. 3, 2005

(51) Int. Cl. A62B 9/06

(52) U.S. Cl. 128/207.17; 128/201.22

(57) ABSTRACT

The present invention is directed to a series of devices designed to assist a patient's respiration and administer fluid to the patient, by ensuring such devices cannot be inadvertently removed from the patient in the absence of medical personnel and cause unwanted injury to the patient. At the same, time, a device is provided to assist a patient's breathing in the absence of such assistive devices, e.g., during sleep.

### BACKGROUND OF THE INVENTION

The present invention is directed to a series of devices designed to assist a patient during respiration and/or invasive administering of fluid. More particularly, the present invention is directed to a series of devices designed to immobilize medical or respirational equipment inserted into a patient to avoid unwanted injury to the patient while, at the same time, ensuring effective medical treatment and/or respiration of the patient.

It is well-known that several invasive devices, e.g., intravenous tubing, assistive respirational devices such as endotracheal tubing, can cause a great deal of injury if accidently pulled out of or pushed into a patient. At the same time, assisting respiration of a patient, e.g., during sedation or even sleep, without need for such assistive respirational devices, is a preferred goal.

### SUMMARY OF THE INVENTION

Accordingly, it is an object of the present invention, to enhance respiration of an individual, especially when such individual might be unconscious.

It is also an object of the present invention to enhance ease of positioning and effectiveness of assistive devices for respiration, while maintaining as much comfort as possible for the patient.

It is a further object of the present invention, to enhance positioning and securing of conduits administering fluid to a patient or otherwise assisting in respiration or other medical treatment, to eliminate danger associated with use of such invasive devices.

These and other objects are attained by the present invention, which is directed to a device for thrusting a jaw of a patient forwardly and having at least one curved thrusting member both pivotally and translationally mounted to fit the patient's jaw and maintain the airway passages in the patient as open as possible. The present invention is also directed to a device for establishing a vacuum within a closed, rigid cage surrounding the neck of a patient to stent the upper airway open. A device of positioning and immobilizing a conduit administering respirational gases into a patient's body is also provided, especially for securing a nasally, orally or endotracheally inserted tubing into the patient.

The inventive devices provide secure, stabilization of the patient during respiration, minimizing discomfort of the patient while, at the same time, ensuring the requisite tubing cannot be inadvertently pulled out of or pushed too far into the patient.

### BRIEF DESCRIPTION OF THE DRAWINGS

The present invention will be described in greater detail with reference to the accompanying drawings in which

FIG. 1 illustrates a perspective view of a device for thrusting a jaw of a patient forwardly, in accordance with the present invention;

FIG. 1A illustrates a perspective view of a portion of an alternative embodiment of the jaw thrusting device illustrated in FIG. 1;

FIG. 2 illustrates a perspective view of a device for establishing a vacuum within a closed, rigid cage surrounding the neck of a patient to stent the upper airway open, in accordance with the present invention;

FIG. 3 illustrates an enlarged view, partially in section, of the encircled area 3 in FIG. 2;

FIG. 4 illustrates a perspective view of the device shown in FIG. 2 from an interior direction thereof;

FIG. 5 illustrates a perspective view of a device for positioning a conduit in accordance with the present invention;

FIG. 6 illustrates a perspective view of a device similar to the one shown in FIG. 5 and positioned about another part of a patient;

FIG. 7 illustrates a perspective view of a device for positioning a tube through the nose or mouth of a patient in accordance with the present invention;

FIG. 8 illustrates a bottom plan view in the direction of arrows 8-8 shown in FIG. 7;

FIG. 9 illustrates a perspective view of a device for positioning a tube inserted into a patient through the nose, mouth or endotracheally in accordance with the present invention; and

FIG. 10 illustrates a perspective view of a device for positioning and securing a tracheostomy tube in accordance with the present invention.

### DESCRIPTION OF THE PREFERRED EMBODIMENTS

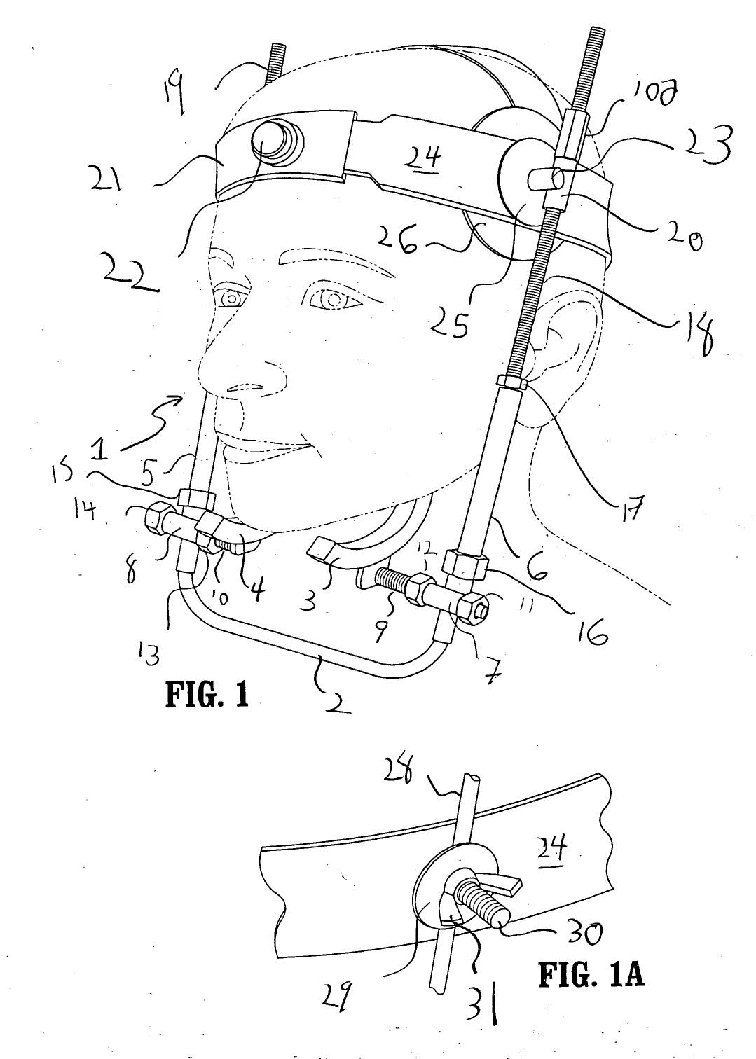

Referring to the drawings in the present application, FIG. 1 illustrates a device 1 for thrusting the jaw of a patient forwardly to permit the patient to breath freely during sedation or sleeping. This device 1 can also be used to treat sleep apnea. The device 1 comprises a pair of curved thrusting members 3,4 designed to seat under the angle of the mandible as shown, and arranged to be both pivotally and translationally mounted to accommodate the size, shape and camber of a particular patient's jaw.

More particularly, a U-shaped member 2 has two legs 18, 19 in the form of screws and extending through respective cylinders 6,5. Jaw thrusting members 3,4 are pivotally and translationally mounted upon these respective cylinders 7, 8 respectively soldered on cylinders 6 and 5 (these cylinders are composed of metal). The jaw thrusting members 3,4 are each mounted upon screws 9 and 10 which are in turn positioned within respective cylinders 7 and 8 and secured in position and tilt by nuts 12, 11 13 and 14. Therefore, the orientation of jaw thruster members 3 and 4, i.e., the tilting thereof and distance from one another, can be adjusted and then fixed to accommodate any shape of a jaw of a patient.

Additionally, the legs 18 and 19 of the U-shaped member is secured to a headband 24 having an adjustable circumference when positioned about a head of a patient by turning knob 22. Reference numeral 21 illustrates bucking mechanism to secure ends of the headband 24 together. Plastic discs 25, 26 are mounted upon headband 24 and, in turn, comprise metallic protrusions 23 to which copper cylinders 20 are soldered and through which legs 18 and 19 pass. Extension of these legs 18 and 19 through respective cylinders 20 is fixed by tightening nuts 100 against the respective cylinders 20. Additionally, position of legs 18 and 19 through respective cylinders 6 and 5 is fixed by tightening respective nuts 16, 17, 15, etc.

Therefore, the jaw thrusting device 1 can be adjusted to accommodate any size, shape or orientation of a patient's head and jaw, and specifically position thrusting members 3 and 4 to forwardly jut a patient's jaw to ensure unobstructed breathing, especially during sedation or sleeping. A patient's upper airway is therefore maintained patent by mobilizing the mandible and anteriorly pulling the base of the patient's tongue and soft tissue of the pharynx off the entrance to the trachea.

In an alternative construction shown in the partial view of FIG. 1A, plastic disc 29 secured to the headband 24 comprise an extending screw 30 upon which a wing nut 31 is tightened to secure leg 28 of the U-shaped member and which need not be threaded; in other features, this variant comprises the identical components shown in FIG. 1.

A spring mechanism (not illustrated) for biasing the U-shaped member 2 anteriorly, can be positioned, e.g., against headband 24 and legs 18, 19, or within or around protrusions 23.

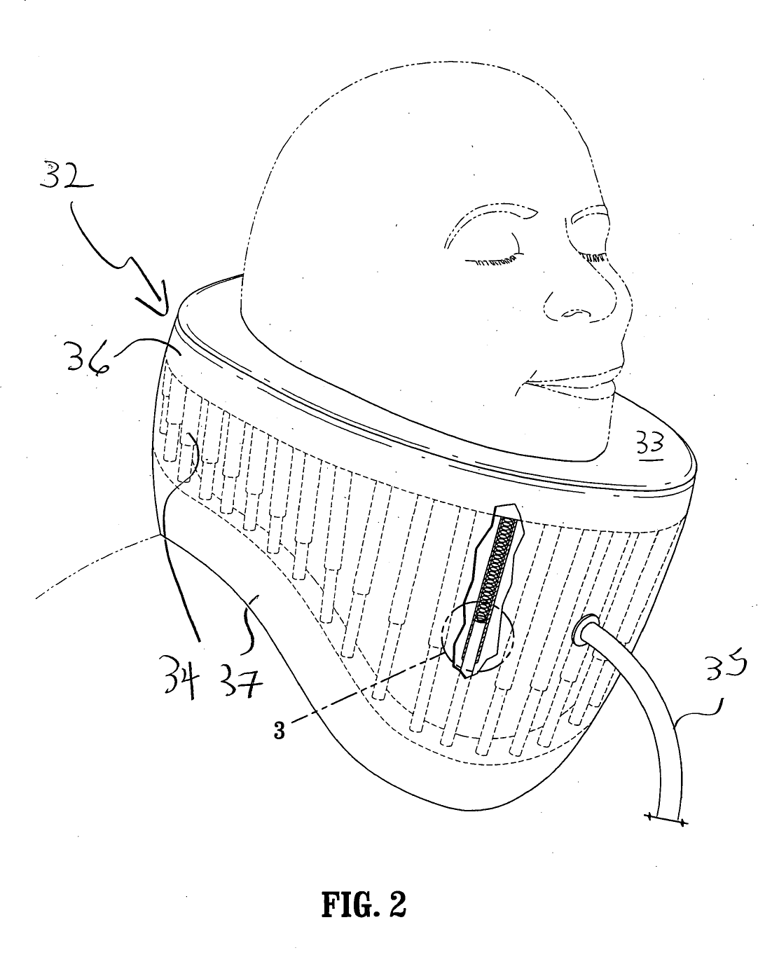

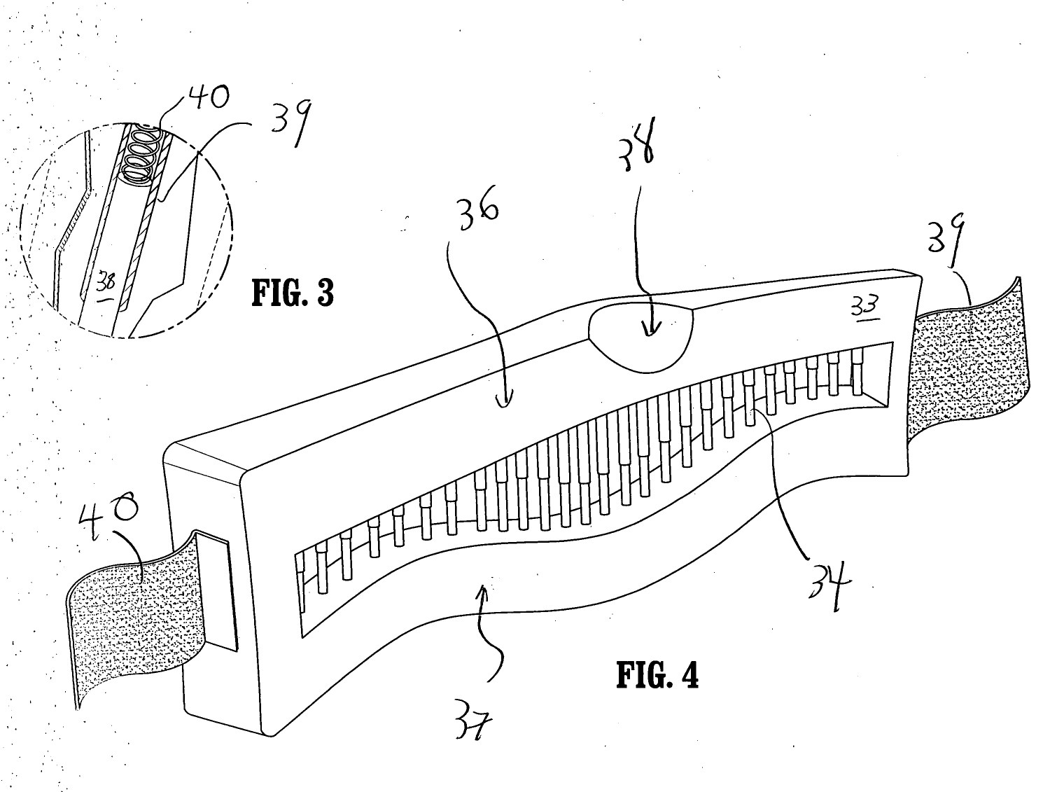

FIG. 2 illustrates a neck supporting device 32 when a vacuum is created around the neck through tube 35 to facilitate breathing by a patient. An outer flexible material made, e.g., of plastic (not shown) surrounds the device 32 and maintains the vacuum created through tube 35. More particularly, the device 32 is composed of a flexible membrane 33, e.g., a foam cushion shaped to encircle a patient's neck and an inner annular opening is cut through the foam cushion 33 to define upper 36 and lower 37 extending portions. As illustrated in FIG. 3, a series of spring-loaded 40 piston 38 and cylinder 39 arrangements, made of rigid plastic, are mounted across the opening between upper 36 and lower 37 extending portions.

The piston-cylinder arrangements 38, 39 are individually biased by the respective springs 40 from one another. The device 32 is secured around a patient's neck by velcro fasteners 39, 40 positioned at lateral ends thereof, with reference numeral 38 denoting a chin-rest cut in the upper extending member 36. The neck support device 32 shown in FIGS. 2 and 3 is extremely responsive to head and neck movement of a patient to comfortably accommodate the patient while a vacuum induced through tube 35 is maintained to stent the upper airway open.

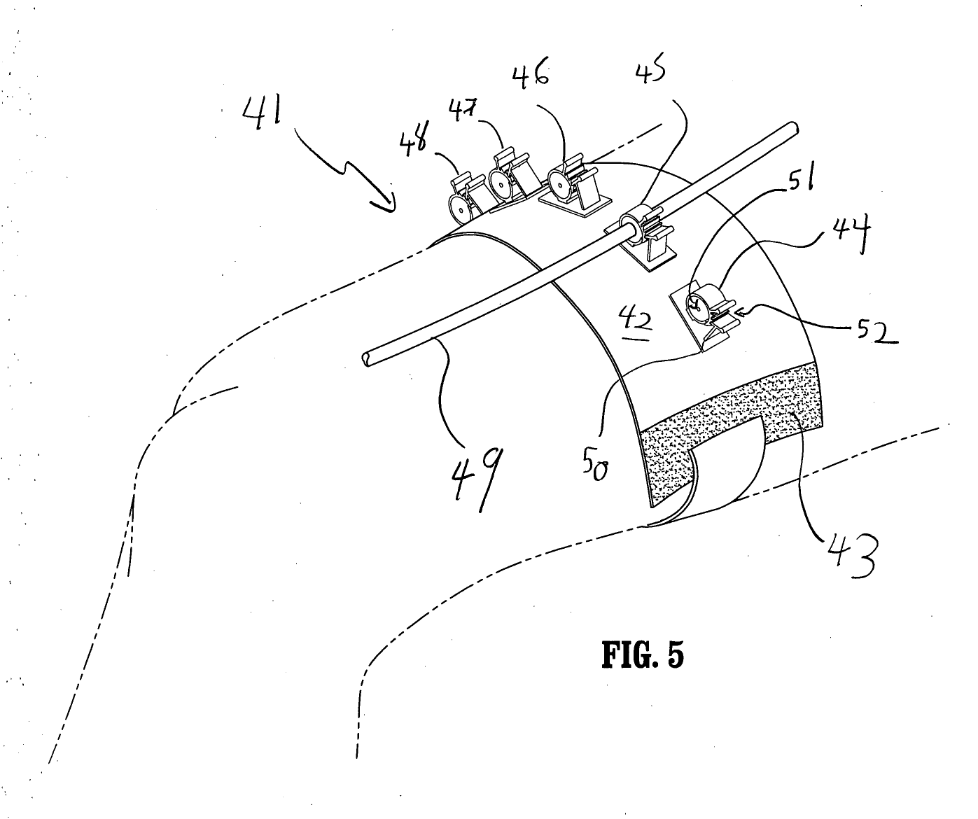

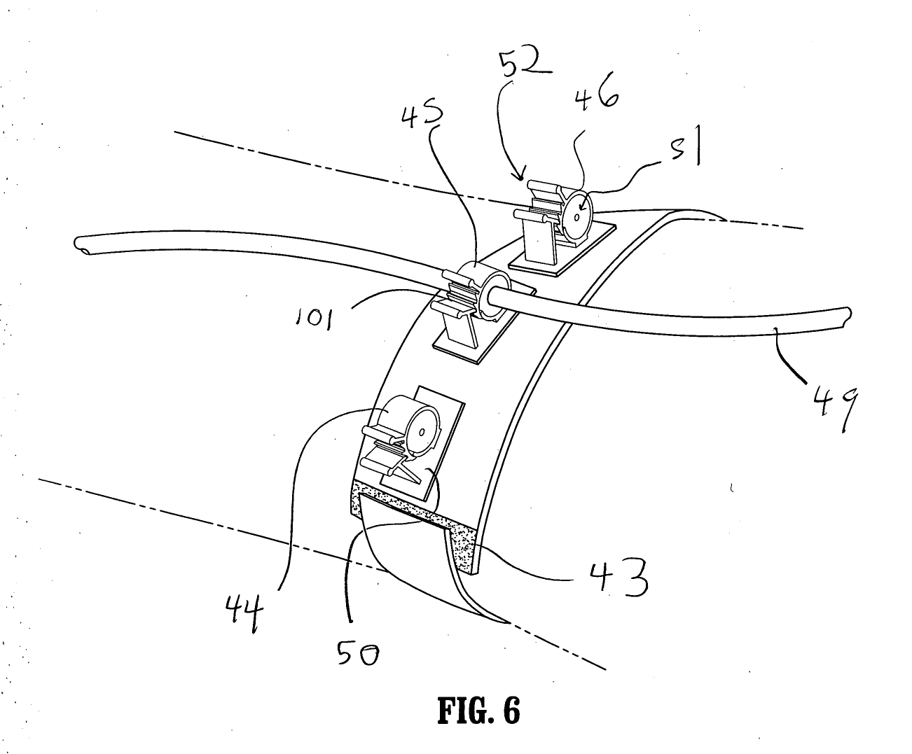

A device for 41 positioning and securing a conduit 49 for administering fluid to a patient, e.g., an intravenous tube, is illustrated in FIG. 5 as comprising a flexible belt 42 arranged to be secured around a patient's thigh by velcro fasteners 43 at opposite ends thereof. A series of ratchet clamps 44, 45, 46, 47, 48, etc. are mounted upon the belt 42 at respective bases 50. Each of these ratchet clamps 44, 45, 46, 47, 48, etc. comprises an opening 51 through which the tubing 49 is passed and a coupling snap 52 arranged to secure the tubing 49 passed through the respective clamp. As best seen in FIG. 6, the coupling snap 52 comprises a series of gradations 101 so that the tubing 49 can be securely retained by the coupled ratchet while, at the same time, flow of fluid through the tubing 49 remains unrestricted. FIG. 6 illustrates alternative positioning of a device similar to, but smaller than, device 41 around a forearm of a patient, instead of the patient's thigh as shown in FIG. 5.

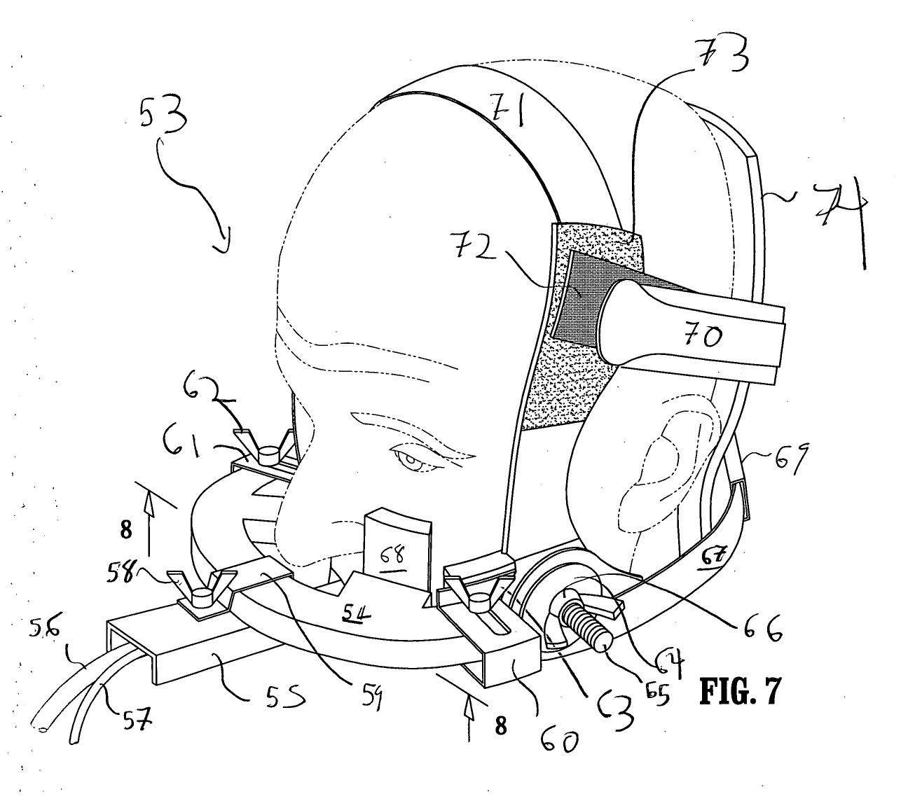

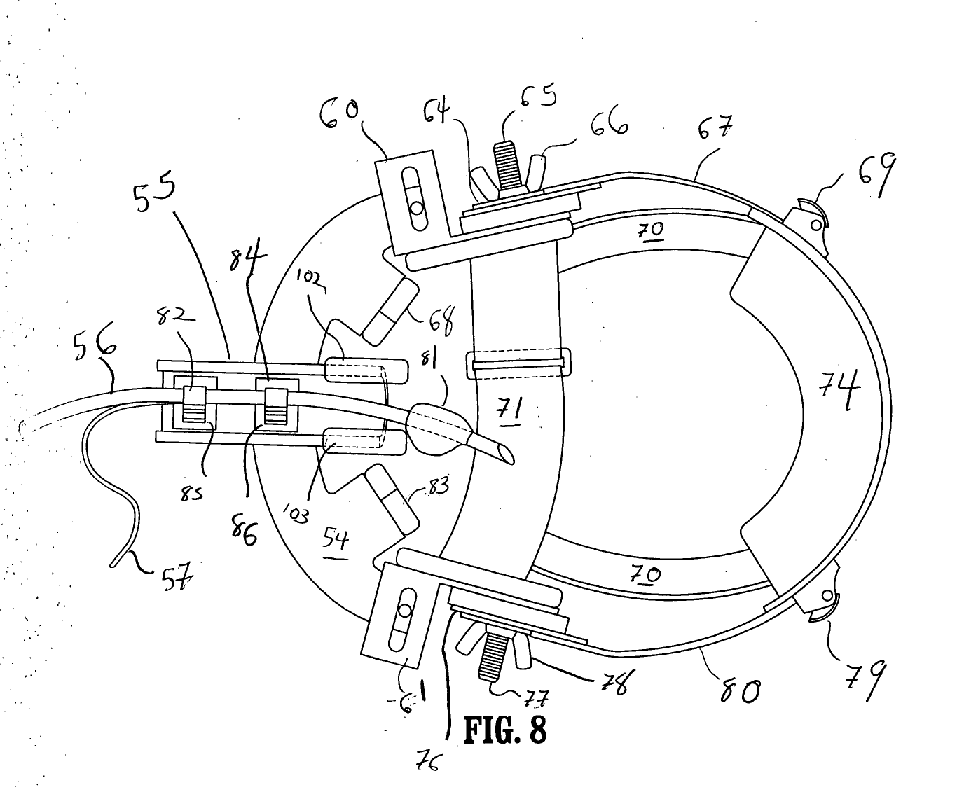

FIGS. 7 and 8 illustrate a device 53 for positioning and securing nasally or orally inserted tubes into a patient. In the embodiment illustrated in these two figures, an endotracheal breathing tube 56 and tube 57 carrying air to or from a cuffed balloon 81 are orally inserted through a patient's mouth and securely retained in position, so that the respective tubing 56, 57 cannot be pulled out or pressed in. A fiberglass platform 54 is adjustably secured to headgear to be positioned in front of a patient's face and retain an inverted U-shaped guide 55 secured thereto by a clamp 59 and wing nut 58. Ratchet clamps 82 and 84, similar to the ratchet clamps illustrated in the embodiments of FIGS. 5 and 6 supra, are secured to the underside of U-shaped guide 55 at respective bases 85, 86. Reference numerals 102 and 103 denote bite pads of a patient's teeth, to prevent the patient from biting the tubing 56, 57 and interfering with respiration.

Fiberglass platform is cut with protrusions having cushions 68, 83 formed of soft foam or plastic material, at ends thereof and designed to seat against a patient's cheek. The headband itself comprises straps 71 and 70 designed to respectively wrap around the top and back of a patient's head and secure a plastic support 74 to the back of the patient's head as shown to provide comfort. These straps 71 and 70 are fastened to each other with velcro fasteners 72. An adjustable belt 67,80 is also provided to encircle the patient's neck and pass through a shield or guide 69 and be secured in position by ratcheting clamps or buckles 69 and 79.

The frontal platform 54 is secured to this belt 67, 80 through adjustable guides 60 and 61 positioned at opposite ends of the curved platform by tightening respective wing nuts 63. These clamps or guides 60 and 61 are, in turn, secured to the respective belt member 67 or 80 through respective screws 65, 77 mounted upon the belt members 67 or 80 and secured in place by the respective wing nuts 66, 78. Loosening the wing nuts 66, 78 allows the frontal platform 54 to be tilted with respect to belt members 67, 80 and allowing a change in angle of the frontal platform 54 with respect to the vertical, while loosening wing nuts 62, 63 allows the overall width of the device 53 between a patient's cheek to be adjusted, to thereby accommodate any size, shape or orientation of a patient's jaw.

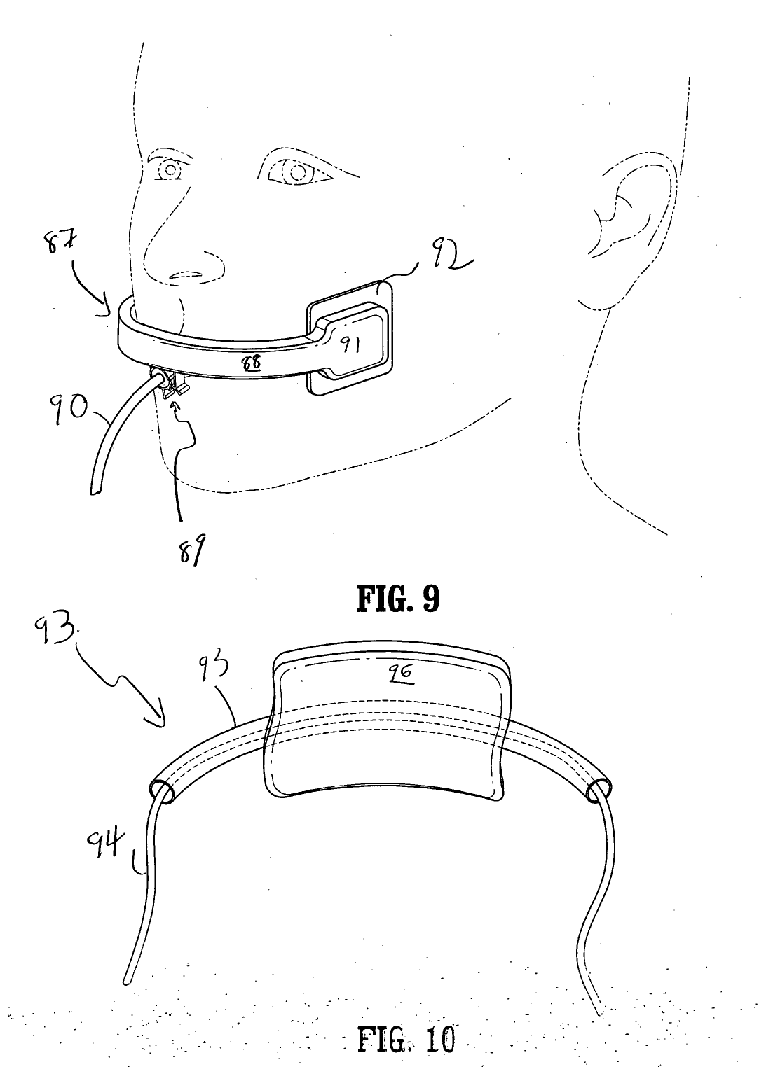

In FIG. 9, a device 87 for positioning an endotracheal tube 90 comprises a rigid, curved member 88 having adhesive pads 92 at opposite flared ends 91 thereof, with a ratchet clamp 89, similar to the ratchet clamps in the other embodiments described supra, being secured at a bottom end of the member 88 and arranged to position and secure the tubing 90 passing therethrough. FIG. 10 illustrates a padded device 96 attached to a tubular structure 93 composed of gel or foam through which a string 94 is passed and tied to the wings (not shown) of a tracheostomy tube. This device is designed to prevent skin breakdown on the neck of a patient while securing a tracheostomy tube.

The preceding description of the present invention is merely exemplary and not intended to limit the scope thereof in any way.

What is claimed is:

1. A device for thrusting a jaw of a patient forward, comprising
at least one curved thrusting member shaped to fit and support the jaw of the patient,
a U-shaped member on which said thrusting member is pivotally mounted, said U-shaped member comprising a bridge and two legs extending therefrom and being adjustable in length, and
a band upon which said legs are adjustably and pivotally mounted and arranged to be secured around a head of the patient,
such that said thrusting member can be clamped in position and maintain the patient's jaw thrust forwardly.

2. The device of claim 1, comprising a pair of thrusting members, each said thrusting member being pivotally mounted upon a respective leg of said U-shaped member.

3. A device for stenting the upper airway of a patient open, by utilizing a vacuum within a rigid, airtight cage surrounding the patient's neck, comprising
a flexible membrane shaped to encircle the patient's neck and provided with an inner opening therethrough, and
a series of spring-loaded piston-cylinders mounted across said opening.

4. The device of claim 3, additionally comprising a tube through rigid walls of the device and coupled to a vacuum.

5. Device for positioning a conduit for administering fluid to a patient upon the patient's body, comprising
a belt structured and arranged to be secured around a limb, torso or other body part of the patient, and
at least one ratchet clamp secured upon the belt and structured and arranged to receive the conduit through an opening therein and position the conduit upon the patient's body without restricting flow of the fluid through the conduit.

6. The device according to claim 5, structured and arranged to additionally immobilize the conduit upon the patient's body.

7. The device according to claim 5, comprising a series of said ratchet clamps secured upon the belt.

8. Device for positioning and securing a nasally or orally inserted tube in a patient, comprising
a platform structured and arranged to be positioned in front of a nose or mouth of a patient, receive the tube inserted into or being inserted into the patient and guide and position the same, and
headgear upon which said platform is adjustably mounted in both translational and pivotal directions.

9. The device according to claim 8, wherein said headgear comprises
a first strap structured and arranged to pass around a rear of a patient's neck,
two pivot axes arranged at respective opposite ends of said first strap,
two pivotal members, each said pivotal member structured and arranged to be pivotally mounted upon a respective pivot axis and secured in position thereon, and
means for adjustably coupling said platform on said pivotal members, such that said platform can be moved towards and away from a patient's face and secured in appropriate position thereon.

10. The device according to claim 9, additionally comprising
a second strap structured and arranged to pass around a head of the patient and be secured to said first strap at or near said pivot axes.

11. Device for positioning and securing a nasally, orally or endotracheally inserted tube in a patient, comprising
a flexible member structured and arranged to seat against a face or neck of the patient, and
a ratchet clamp secured to said flexible member and structured and arranged to receive, position and secure the tube passing therethrough without restricting flow of fluid through the tube.

12. The device according to claim 10, wherein the flexible member comprises two adhesive pads situated at opposite ends thereof.

13. The device according to claim 10, wherein said flexible member comprises a string structure and arranged to be tied to a tracheostomy tube at opposite ends thereof,
a flexible tube structured and arranged to receive the string which passes therethrough, and
a cushion mounted upon said flexible tube and structured and arranged to be positioned against a back of a neck of the patient.
